(19) United States
(12) Patent Application Publication
(10) Pub. No.: US 2009/0139738 A1
(43) Pub. Date: Jun. 4, 2009

(54) Screwing Tool And Method For Controlling The Tightening Angle Of Screwed Joints

(76) Inventor: Peter Lippek, Heubach (DE)

Correspondence Address: ST. ONGE STEWARD JOHNSTON & REENS, LLC, 986 BEDFORD STREET, STAMFORD, CT, 06905-5619, US

(21) Appl. No.: 12/328,084

(22) Filed: Dec. 4, 2008

(30) Foreign Application Priority Data
Dec. 4, 2007 (DE) 10 2007 059 929.5

(51) Int. Cl. B25B 23/14; B25B 23/147

(52) U.S. Cl. 173/181; 173/183; 173/182; 173/166

(57) ABSTRACT

The invention proposes a method for controlling the tightening angle of screwed joints when tightening is effected using a hand-held screwing tool, wherein the torque is monitored until a predefined threshold value is reached, the angle of rotation is measured from the point the threshold value has been reached, the relative rotation of the screwing tool relative to the screwed joint is measured from the point the threshold value has been reached, and the screwing tool is switched off when a predetermined angle of rotation is reached, taking into account the relative angle of rotation of the screwing tool relative to the screwed joint as a corrective value.

### CROSS-REFERENCE TO RELATED APPLICATIONS

The present application claims priority of German patent application No. 10 2007 059 929.5 filed on Dec. 4, 2007, the content of which is incorporated herein by reference.

### BACKGROUND OF THE INVENTION

The present invention relates to a method for controlling the tightening angle of screwed joints when tightening is effected using a hand-held screwing tool.

The invention further relates to a screwing tool having a cut-off mechanism that permits the screwing tool to be switched off as precisely as possible when a predefined tightening angle is reached.

Industrial screwed joints serve to connect two or more elements by screws. It is the basic idea of such connections that a defined preload force is to be produced in the elements which provides a safe connection that will neither untighten, nor be overstressed nor break under load. Such defined preload force is achieved, with greater of lesser deviation, by the screw-tightening methods known as “torque-controlled”, “angle-controlled” or “extension-controlled” methods.

The angle controlled method is regarded as a very precise method. It is employed for producing precise screwed joints using stationary jack screws. In that case, the angle of rotation of the output shaft can be determined via an angle measuring instrument installed in the screwing tool, starting from the point when a defined threshold torque has been exceeded. As the jack screw is stationary and takes up the reaction torque encountered during tightening of the screw, the angle so measured will correspond to the tightening angle of the screw.

In the case of hand-held screwing tools, a worker is required to hold the reaction torque encountered during tightening of the screw. Of course he will not be in a position to hold the screwing tool exactly in its initial position, especially when higher torques are encountered. Consequently, as a rule greater or lesser deviations from the preset tightening angle of the screwed joints will be encountered in practice.

In view of this, it is a first object of the invention to disclose an improved method for controlling the tightening angle of a screwed joint which allows a predefined tightening angle to be observed very precisely even in the case of hand-held screwing tools.

It is a second object of the invention is to disclose a hand-held screwing tool suitable for precisely controlling the tightening angle of a screwed joint.

### SUMMARY OF THE INVENTION

According to the invention these and other objects are solved by a method for controlling the tightening angle of screwed joints during a tightening process using a hand-held screwing tool, comprising the steps of:
monitoring the torque until a predefined threshold value is reached;
measuring the angle of rotation after the threshold value has been reached;
measuring the rotation of the screwing tool relative to the screwed joint after the threshold value has been reached;
switching off the electric tool when a predetermined angle of rotation is reached, taking into account the angle of rotation of the screwing tool relative to the screwed joint as a corrective value.

According to the invention these and other objects are further achieved by a screwing tool comprising the following features:
an output shaft that can be driven by a drive;
a cut-off mechanism for switching off the drive when a predefined angle of rotation of the output shaft has been reached;
a torque measuring system for measuring the torque during a screwing operation, until a predefined threshold value is reached;
an angle measuring system for measuring the angle of rotation of the output shaft after the predefined threshold value has been reached;
an angle measuring system for measuring a relative rotation between the screwing tool and the screwed joint; and
a control device that cuts off the drive once a predefined angle of rotation of the output shaft is reached, after the point when a threshold value had been reached, taking into account a relative rotation between the screwing tool and the screwed joint.

The invention provides for measuring the relative rotation of the screwing tool on the basis of the reaction torque, using that value as a corrective quantity in determining the angle of rotation of the output shaft. This completely eliminates any inaccuracies of the kind previously caused by the rotation of the screwing tool relative to its initial position. Accordingly, very precise tightening angles can be guaranteed for screwed joints even when hand-held screwing tools are employed for tightening the screwed joint.

Another embodiment of the method according to the invention provides that the angle of rotation of the output shaft of the screwing tool is measured, from the point when the threshold value has been reached, and the angle of rotation of the screwed joint is determined from the difference between the angle of rotation of the output shaft and the relative angle of rotation between the screwing tool and the screwed joint: α=β−γ.

Conveniently, the control device of the screwing tools is designed to cut off the drive when an angle of rotation of the screwed joint is reached that is determined by the difference between the angle of rotation of the output shaft encountered from the point when the threshold value has been reached, and the angle of rotation of the screwing tool relative to the screwed joint: α=β−γ.

The angle measuring device used for measuring the angle of rotation of the output shaft may consist, for example, of a pulse coding disc with double arm photo sensor or an angular position encoder.

The torque measuring device may consist, for example, of a strain gauge torque sensor.

Further, for measuring the relative rotation of the screwing tool relative to the screwed joint, the angle measuring device may comprise an acceleration sensor or a gyroscope, for example.

It is understood that the features of the invention mentioned above and those yet to be explained below can be used not only in the respective combination indicated, but also in other combinations or in isolation, without leaving the scope of the invention.

Further features and advantages of the invention will become apparent from the description that follows of certain preferred embodiments of the invention, with reference to the drawing.

### BRIEF DESCRIPTION OF THE DRAWING

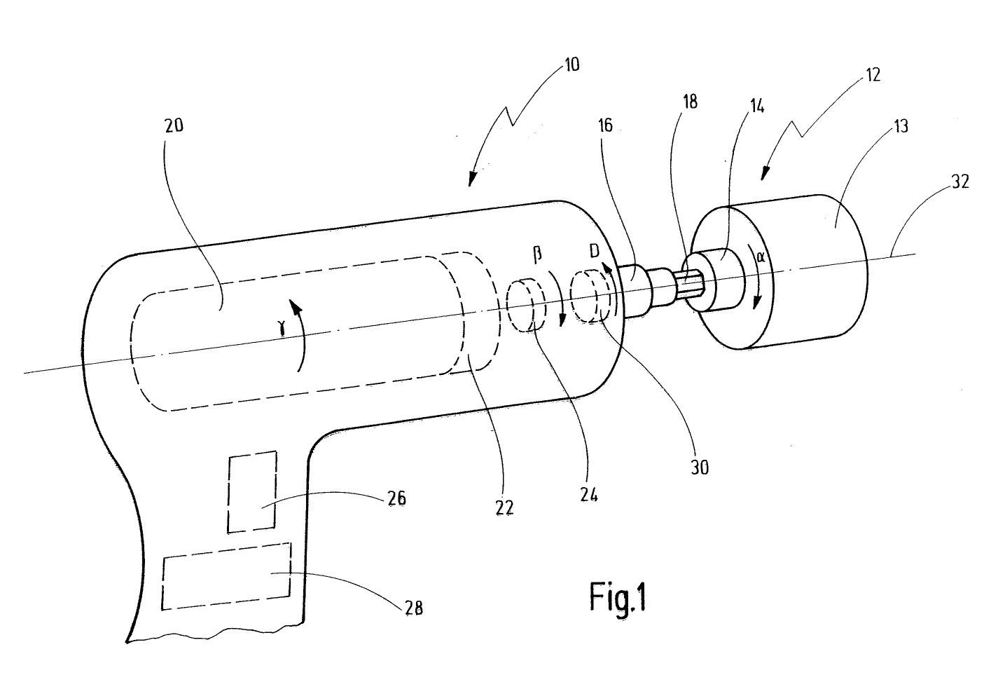

The single FIG. 1 shows a schematic sketch of a screwing tool according to the invention, with a screwed joint being tightened using a bit.

### DETAILED DESCRIPTION OF THE PREFERRED EMBODIMENT

In FIG. 1, tightening of a screwed joint 12 is to be effected by tightening a screw 14 against a work piece 13 over a predefined angle of rotation.

A hand-held screwing tool 10 used for this purpose comprises an output shaft 16 in which a bit 18 is received for tightening the screw 14.

The output shaft 16 is driven by a drive 20 (for example an electric motor) which is coupled to the output shaft 16 via a cut-off device 22. Further, the output shaft 16 is engaged by a torque-measuring system 30 for measuring the torque D transmitted by the screwing tool 10.

There is further provided on the output shaft 16 an angle measuring system 24, for example in the form of a pulse coding disc with double arm photo sensor, which senses the angle of rotation β of the output shaft 16 after a predetermined threshold value has been reached.

Further, the screwing device 10 comprises a measuring system 26 for measuring the relative movement between the screwing tool 10 and the screwed joint 12 or the work piece 13.

That measuring system 26 may be a measuring system comprising an acceleration sensor, for example.

The operation of the screwing tool according to the invention is as follows:

The screwing tool 10 is initially applied to the screw 14 via a suitable tool, for example a screwdriver bit 18. Then the drive 20 is switched on and the screw 14 is tightened against the work piece 13. Once the torque measuring system 30 senses that a predefined threshold of the torque D has been reached, the angle measuring system 24 starts measuring the angle of rotation β of the output shaft. At the same time, the measuring system 26 monitors any relative rotation occurring between the screwing tool 10 and the work piece 13. The screwing tool 10 is switched off as soon as a predetermined tightening angle α of the screw 14 relative to the work piece 13 has been reached. The angle of rotation α is determined by the difference between the angle of rotation β of the output shaft and the relative angle of rotation γ between the screwing tool 10 and the tool 13.

What is claimed is:

1. A method for controlling the tightening angle of screwed joints using a hand-held screwing tool, comprising the steps of:
monitoring torque until a predefined threshold value is reached;
measuring an angle of relative rotation from the point the threshold value has been reached;
measuring rotation of the screwing tool relative to the screwed joint from the point the threshold value has been reached;
switching off the electric tool when a predetermined angle of rotation is reached, taking into account the relative angle of rotation of the screwing tool relative to the screwed joint as a corrective value.

2. The method as defined in claim 1, wherein the angle of rotation of the output shaft of the screwing tool is measured, from the point when the threshold value has been reached, and the angle of rotation of the screwed joint is determined from the difference between the angle of rotation of the output shaft and the relative angle of rotation between the screwing tool and the screwed joint: α=β−γ.

3. A screwing tool comprising:
a drive for driving an output shaft;
a cut-off mechanism for switching off said drive when a predefined angle of rotation of said output shaft has been reached;
a torque measuring mechanism for measuring torque during a screwing operation, until a predefined threshold value is reached;
an angle measuring mechanism for measuring the angle of rotation of the output shaft from the point the predefined threshold value has been reached;
an angle measuring system for measuring a relative rotation between the screwing tool and a screwed joint; and
a control device configured for cutting off said drive once a predefined angle of rotation of the output shaft is reached, after the point when a threshold value had been reached, taking into account a relative rotation between said screwing tool and said screwed joint.

4. The screwing tool as defined in claim 1, wherein said control device is configured for cutting off said drive when an angle of rotation of the screwed joint is reached that is determined by a difference between the angle of rotation of the output shaft encountered after the point the threshold value has been reached, and a relative angle of rotation of the screwing tool relative to the screwed joint (12):
α=β−γ

5. The screwing tool as defined in claim 4, wherein said angle measuring device comprises an angular position encoder.

6. The screwing tool as defined in claim 4, wherein said angle measuring device comprises a pulse coding disc with double arm photo sensor

7. The screwing tool as defined in any of claim 3, wherein said torque measuring device comprises a strain gauge torque sensor.

8. The screwing tool as defined in claim 3, wherein said angle measuring device comprises an acceleration sensor.

9. The screwing tool as defined in claim 3, wherein said angle measuring device comprises a gyroscope.

10. The screwing tool as defined in any of claim 4, wherein said torque measuring device comprises a strain gauge torque sensor.

11. The screwing tool as defined in claim 4, wherein said angle measuring device comprises an acceleration sensor.

12. The screwing tool as defined in claim 4, wherein said angle measuring device comprises a gyroscope.

13. The screwing tool as defined in claim 10, wherein said angle measuring device comprises an acceleration sensor.

14. The screwing tool as defined in claim 13, wherein said angle measuring device comprises a gyroscope.
